(19) United States
(12) Patent Application Publication
(10) Pub. No.: US 2008/0091513 A1
(43) Pub. Date: Apr. 17, 2008

(54) SYSTEM AND METHOD FOR ASSESSING MARKETING DATA

(75) Inventor: James Hallowell Waggoner, Upper Montclair, NJ (US)

Correspondence Address: OSTROLENK FABER GERB & SOFFEN, 1180 AVENUE OF THE AMERICAS, NEW YORK, NY, 100368403, US

(73) Assignee: VIDEO MONITORING SERVICES OF AMERICA, L.P., New York, NY (US)

(21) Appl. No.: 11/854,771

(22) Filed: Sep. 13, 2007

Related U.S. Application Data
(60) Provisional application No. 60/844,177, filed on Sep. 13, 2006.

(51) Int. Cl. G06Q 30/00; G06F 17/30; G06F 17/40

(52) U.S. Cl. 705/10; 705/14

(57) ABSTRACT

The present invention includes a system and method for managing media received from a plurality of media sources. Media content is received from a media source over a communication network. The media content is formatted in a first format and comprises news and advertising material relating to a respective subject. The received media content is processed into processed content, wherein the processing includes filtering, annotating and standardizing the content. Moreover, processed content is rendered, wherein the rendering includes transforming the processed content from the first format into a second format. The processed content formatted in the second format is stored in an electronic storage repository, and, in response to a search for the processed content, the processed content is retrieved from the electronic storage repository. Further, the processed content is further transformed from the second format to a third format, and delivered in the third format to a user.

### CROSS-REFERENCE TO RELATED APPLICATION

This application is based on and claims priority to U.S. Provisional Patent Application Ser. No. 60/844,177, filed on Sep. 13, 2006 and entitled SYSTEM AND METHOD FOR ASSESSING MARKETING DATA, the entire contents of which are hereby incorporated by reference.

### BACKGROUND

1. Field of the Invention

The present invention relates to media monitoring services, and, more particularly, to an integrated computerized platform of reusable services associated with media content.

2. Description of the Related Art

A Media Prominence Index (“MPI”) is a metric that has shown to be a reliable measure of communications effectiveness. Generally, the higher the MPI, the more likely that a particular form of communication (e.g., printed material, broadcast, or web-based media) has an impact.

MPI employs a metric known in the art as a media value, previously referred to as an ad value equivalency. As used herein, the term, media value, refers generally to a market driven value of a print, broadcast, or internet placement based on the cost or rate that media source (e.g., the outlet in which coverage appears) would charge if that space could be purchased. Various factors, including the credibility of the source, the source's audience reach and the length of the news coverage may impact the media value. Media values use the rate that a media source would charge for placing an advertisement and applies that rate to the space or time for the message. For example, a 3 column-inch (a standard measure of space, primarily for newspaper advertising, wherein one column-inch is one standard newspaper column wide (2 1/16″) by 1″ high) article in the New York Times would be valued as if a 3 column-inch advertisement was purchased. Broadcast sources would state their rates not in column-inches, but as the cost per 30-second commercial. Media value is therefore a market-driven metric.

The use of media values as the basis for an MPI has a strong foundation. Research has demonstrated that measuring the effectiveness of a person's or organization's media outreach by calculating media values is 13% more likely to correlate to an outcome than using the known “impressions” standard, and 25% more likely than the known “story counts” standard. Thus, audience impressions are 12% more likely to correlate to an outcome than using story counts.

Typically, impressions differentiate between a relatively low-reach publication and a relatively high-reach publication, for example, the Des Moines Register versus the New York Times, respectively. However, a 2-second broadcast segment that generates the same number of impressions as a 2-minute broadcast segment indicates that the impressions metric does not sufficiently capture the full impact of all media placement. Media value not only differentiates between higher reach sources but also takes into account the degree of coverage. Media value further differentiates between sources with lower credibility, such as supermarket tabloids, versus highly credible sources like the New York Times.

Media value also differentiates between articles in which a person or organization is mentioned alone versus articles in which the person/organization shares coverage, for example, with a competitor. In case a person is mentioned alone, the media value factors full credit for the person/organization for the value of that coverage. Alternatively, if coverage is shared, only an appropriate fraction of that coverage is factored.

The MPI metric uses the media value and further modifies it by additional variables, “tone” and “prominence.” As used herein, tone refers, generally, to the editorial “attitude” a news item conveys toward a company. In a preferred embodiment, tone is coded on a 9-point scale where 9 represents extremely positive, 8 represents very positive, 7 represents positive, 6 represents somewhat positive, 5 represents neutral/balanced, 4 represents somewhat negative, 3 represents negative, 2 represents very negative and 1 represents extremely negative. Prominence, generally, represents a measure of the likelihood that the news coverage will have an impact. Prominence is highest where the company or message is in the headline or lead paragraph and is lowest when the mention is near the end of an article.

The more likely that coverage is to be seen, the higher the prominence score. Like tone, prominence is preferably measured on a 9-point scale.

With respect to tone, for example, a negative article generates a negative value. A neutral article has less value than a positive article, while a very positive article has a higher value than just a modestly positive article. Preferably, tone is measured on a 9-point scale wherein a value of 1 represents very negative, a value of 5 is neutral, and 9 is very positive.

MPI is also modified by prominence. If a person/organization is mentioned in a headline or lead paragraph, then that person/organization is more likely to be read and noticed by others. Therefore, the MPI increases by a percentage value to reflect such greater likelihood to generate impact. On the other hand, if the mention is buried at the very end of the article, it is far less likely to be noticed and therefore the MPI is reduced.

Tone has more impact in the MPI metric than prominence. A very positive article where a person/organization is mentioned in the article's headline has almost double the impact of a neutral article where the person/organization is mentioned near the end of the article. The values used are developed through extensive regression analysis to determine the correct weightings.

For example, a 75 word article in the New York Times (3 column-inches) has a Media Value of $3,159.00, and represents the amount that the New York Times charges an advertiser for a 3 column inch advertisement. The article is evaluated for tonality, i.e. the degree of positive or negative attributes. For example, the article is considered to be positive and is rated as a “7” on a 9-point scale from extremely positive to extremely negative. Thereafter, prominence is determined by evaluating where the mention of the individual/organization appears in the article. If the mention appears in paragraph 3 of a 5 paragraph story, prominence may be rated as a “5” on a 9-point scale from headline to footnote.

Thereafter, the Media Prominence Index is calculated by multiplying the media value by a multiplier based on the tonality and a second multiplier based on the prominence. These multipliers are determined through regression analysis from several million articles and fine-tuned through a study of over 200,000 articles.

Example multipliers for tonality are listed in table 102 shown in FIG. 1A. Further, example multipliers for prominence are listed in table 104 in FIG. 1B. FIG. 1C is a table 106 showing various MPI's in accordance with the length in words, column inches, media value, tone, prominence and multipliers.

The Media Prominence Index can be expressed as a dollar metric or without the dollar sign as a unit-less metric.

Further, advertising spending is a metric representing a measure of advertising impact. Typically, advertising metrics are expressed in absolute terms and based on a projected audience reach of the advertisement or the dollar value of the advertisement. An advertisement or advertisement campaign with higher advertising spending will have more impact than one with lower advertising spending.

Although use of MPI and advertising spending, historically, has been useful and incremental developments and improvements over a period of time have led to piece-meal solutions. These solutions by nature do not provide an integrated view of the news and advertising data, are difficult to modify and difficult to enhance due to the 3rd party involved, and backward compatibility of new versions are becoming increasingly difficult due to custom nature of each client installation.

### SUMMARY

The present invention includes a system and method for managing media received from a plurality of media sources. Preferably, media content is received from a media source over a communication network. When received, the media content is formatted in a first format and comprises news and advertising material relating to a respective subject. Thereafter, the received media content is processed into processed content, wherein the processing includes filtering the content, annotating and standardizing the content. Moreover, processed content is rendered, wherein the rendering includes transforming the processed content from the first format into a second format. The processed content formatted in the second format is stored in an electronic storage repository, and, in response to a search for the processed content, the processed content is retrieved from the electronic storage repository. Further, the processed content is further transformed from the second format to a third format, and delivered in the third format to a user.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1A is a table showing multiplier values associated with tonality descriptions;

FIG. 1B is a table showing multiplier values associated with media prominence descriptions for print and broadcast media;

FIG. 1C is a table showing various media prominence indices in accordance with the length in words, column inches, media value, tone, prominence and multipliers;

FIG. 2 is a block diagram that illustrates an example enterprise architecture, including components and processes, provided in accordance with an embodiment;

FIG. 3 is a UML class diagram illustrating relationships of users to sites, and sites to accounts;

FIG. 4 is a block diagram representing a conceptual graphical view of an architecture implemented in accordance with a preferred embodiment;

FIG. 5 is a chart illustrating session security elements that are defined in accordance with a preferred embodiment;

FIG. 6 illustrates steps associated with collection, pre-processing and completion of ingestion;

FIG. 7 illustrates an example template management service display screen in accordance with a preferred embodiment;

FIG. 8 illustrates an example hardware arrangement, in accordance with an embodiment of the present invention; and

FIG. 9 illustrates the functional elements of an example information processor.

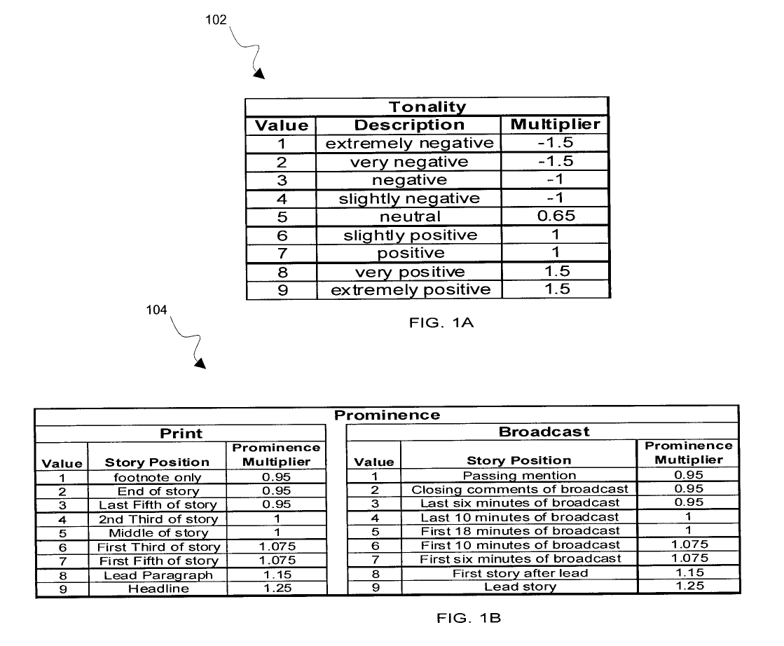

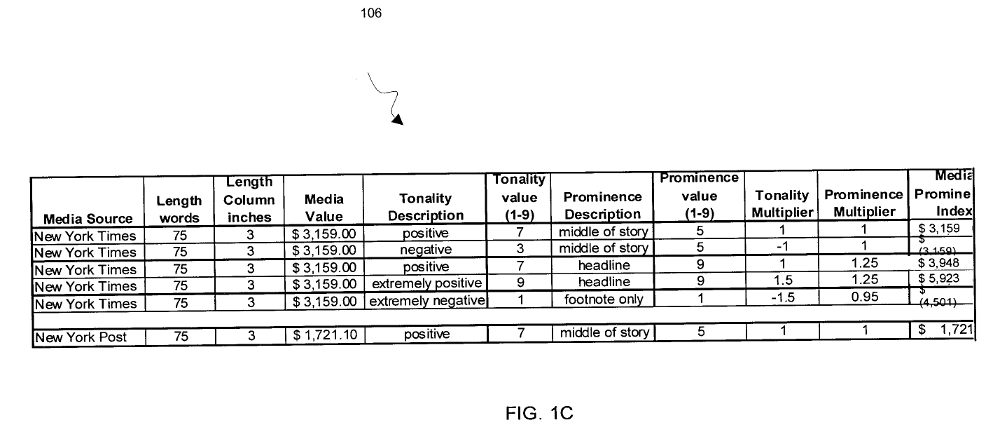

### DESCRIPTION OF EMBODIMENTS

The present invention provides a single unified environment shown in the drawings and referred to herein as Integrated Media Intelligence (“IMI”). The Integrated Media Intelligence environment preferably includes a product line of internet web site (“web-based”) offerings that provides integrated access to a suite of offerings associated with the MPI and advertising spending values, described in greater detail herein. In a preferred business method, a plurality of service offerings are provided that include varying degrees of functionality.

In one embodiment providing a relatively basic service, users contract with a proprietor of the present invention for various information deliverables. Content, which may be provided for a fixed fee, a variable fee or no fee, includes subscription-monitoring reports. Preferably, all media types are supported, including printed media, broadcast media and internet-related media. User-provided material may also be supported. Preferably, users are encouraged to engage in various activities and in return are provided rudimentary reporting and searching services. Various sophisticated features, such as charting or collaborative software elements like show rooms, (described in greater detail, below) are preferably not provided to users in this embodiment. Various services provided to users preferably include online ordering and incremental ad hoc purchases of various offerings, such as tapes, transcripts, Q.V. preview, audience numbers data, media values, MPI, or the like. The system further supports the automation of order processing and billing, thereby allowing users to review account activity. Further in this embodiment, sales and management metrics are provided in support of sales initiatives and general planning. Ordering is preferably supported in both incremental credit card purchases and account base purchasing. Further, this embodiment provides access to and works with other applications in connection with one or more applications, including INSIGHT CONTACTS, NEWSROOM, ADSITE and APEX, offered by the assignee of the present patent application. These applications provide, for example, support for campaign creation, execution and response monitoring, as well as integration with various modules and applications to build a list of media contacts to which new and existing press releases will be distributed. Further, customized media contact lists from a database are preferably used, for example, as the target for campaigns. Further, customers are provided with access to advertising media content and associated information such as impressions and advertising spending and occurrence data. Site visitors also preferably purchase advertising media clips, on-line and on-demand using their credit cards. Also preferably included is the ability to quickly and easily view a company's summary of recent media references using easy-to-read graphical visualizations such as the green-yellow-red stoplight model, and provided in a dashboard view.

An alternative embodiment provides an intermediate level of services and includes features described above and further provides additional storage options, CD delivery of archived material, limited charting tools, user managed folders and collaborative tools like coverage centers and e-mail reporting tools. The package further allows users to add their own content and support data feeds from other third parties, separate from media monitoring parties that track and collect editorial coverage for businesses from a variety of media sources, such as BURRELLESLUCE.

Yet another embodiment provides all of the features of the intermediate level of services, and further incorporates data tagging and the associated additional reports and charts that are derived from the tagged data. This package preferably provides to enable customers to filter, search and sort their respective media coverage from print, broadcast and internet based sources. Users are preferably able to create web enabled reports and charts quickly, to track breaking news, and otherwise to analyze their media coverage. These reports can then be saved or shared with others. Moreover, categorization and coding of the media coverage collected is performed in both an automated and manual manner and ties to the other modules allow users to map their coverage to press releases or detailed information on the media source.

An additional embodiment provides for a customized incorporation of features and includes a facility for completing ongoing custom work for users. Of course, one skilled in the art will recognize that a number of other packages are envisioned and supported. These include; data porting utilities, support for billing and other backend software, and ties to, and porting of, additional user application packages, such as CONTACTS, ADSITE, NEWSROOM, APEX and PRTRAK affiliate calculators.

Yet another embodiment provides for a combined view of editorial and advertising data, combining the MPI values and advertising spending values, and preferably comparing messaging and concepts that are delivered by advertising and editorial/PR programs. This preferably enables a complete view of the communications impact of all programs. A further embodiment provides the ability to compare the communications impacts with business results to help determine the impact and return on investment of communications investments.

Preferably, media content items acquired through the various media channels arrive with metadata, as known in the art, attached. For example, a newspaper article typically includes metadata identifying the publisher and date. A television clip may arrive with the closed caption text attached as metadata. This metadata is often a key component of the media content as it is the basis for the management, reporting and analysis of media items. Preferably, additional metadata is associated with media content at various points, such as during the ingestion process, described below.

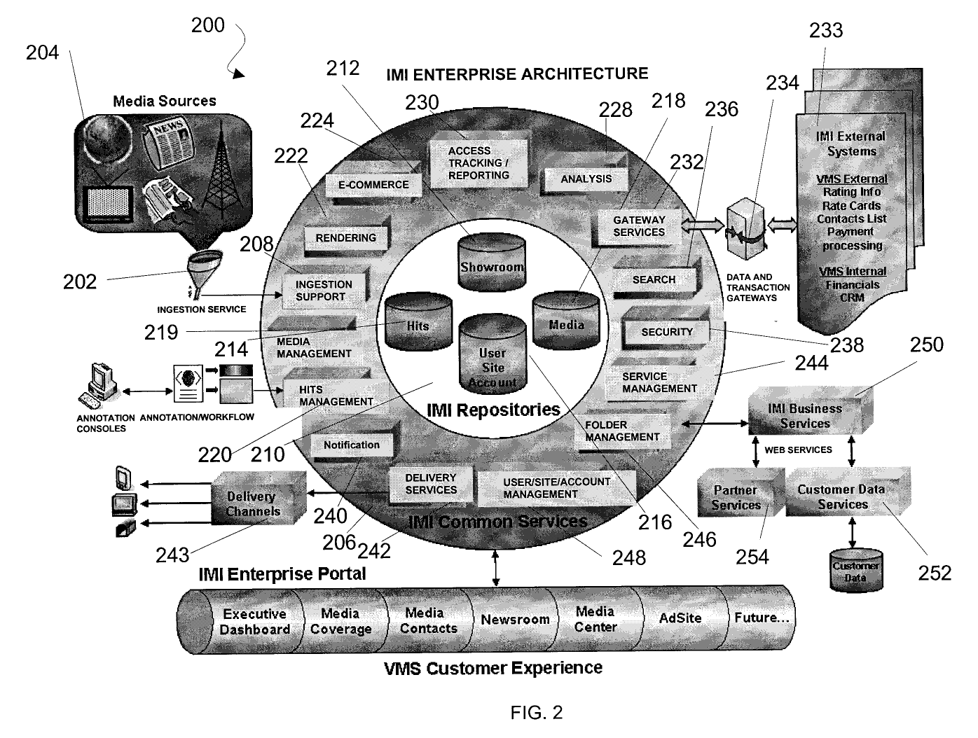

FIG. 2 is a block diagram that illustrates example enterprise architecture 200, including components and processes, provided in accordance with a preferred embodiment. As shown in FIG. 2, a specialized ingestion process 202 preferably processes and annotates media content being supplied by media sources 204. Ingestion service 202 preferably filters the streams of media items from media sources 204 in order to determine which items are of interest to customers. Items for which no customer is deemed to have an interest are preferably discarded, while content items that are selected as “interesting” to a client are preferably processed by the ingestion process 202. Content from media sources 204 is preferably reviewed and modified, for example, to correct existing metadata (e.g., correct errors in closed-caption text) and optionally to create additional metadata, such as an abstract, which may be attached to the media item. Preferably, customers may also add metadata, such as content rating values, as a function of architecture 200. Customer annotation is preferably available at an application level rather than via ingestion process 202. Preferably, metadata added during ingestion process 202 can be client-specific, such as rating and tone values with respect to a particular client-specific subject. This allows custom data to be stored for clients with respect to respective companies and industries.

Also shown in FIG. 2, common services 206 include a set of components that may be used by multiple applications as well as by other common service components. Preferably, common services 206 are formatted to be reusable, thereby providing benefits of reusable code, as known in the art. Furthermore, common services 206 are preferably formatted as modular components that provide for convenient enhancements and modification for future adaptations.

Common services 206 also provide a basis for implementing a service oriented architecture (SOA), which, as used herein, generally refers to a software architectural style that achieves loose coupling among interacting software agents. Preferably, utilizing a SOA provides a sustainable solution that consolidates components of the architecture's value chain and delivers a modular, componentized solution for the future.

In a preferred embodiment, common services 206 include ingestion support 208 that provides an interface between ingestion service 202 and IMI repositories 210. IMI repositories 206 preferably include databases that store information by common services 210 and associated data applications. IMI repositories 210 preferably operate at the core of common services 206 platform and provide a storage area for storing, modifying and accessing data.

Preferably, external systems use a service layer, such as an application programming interface (“API”) layer, as known in the art, to access IMI repositories 210. Also preferably, IMI repositories 210 include showroom repository 212, hits repository 214, user site account access repository 216 and media repository 218. Hits repository 214 and media repository 218 preferably include data related to such assets. Showroom repository 212 preferably enables subscribers to create customized showrooms for on-line “guests.” As used herein, a “guest” represents, generally, a type of user account that is associated with a parent account, typically a subscriber user account. Guest users, typically, are entitled to read-only access to showrooms, which are defined by media center 218 subscribers. Furthermore, the user, site, and account 216 repository preferably contains data for the management of these common entities. Further, common services 206 include media management 219 and hits management services 220 that provide management and access to media content items, including associated metadata, which are preferably stored in the repositories 210. As used herein, “hits” stored in hits repository 214 preferably refer to content that matches a client's interests. For example, hits are generated as a result of keywords/threads and/or notes which provide detailed instructions about hits a particular customer wants and does not want. For example, a customer may define rating/toning instructions, thread definitions, section definitions, issue definitions and track groups, competitors, major media, major regions, publishers, score groups, campaigns, and publishing cutoff times.

User account access repository 216 preferably enables a user to define various levels of data access for users. For example, access repository 216 enables a user to create a guest user, edit guest user attributes and delete a guest user. Further, access repository 216 preferably provides the ability to create a subscriber user, edit user attributes and delete a subscriber user. Other features include: the ability to create a master subscriber user, and to edit user attributes and delete a master subscriber user; the ability to create a partner ASR user, edit the ASR user attributes and delete the user; the ability to create a VMS ASR user, edit the VMS ASR user attributes and delete the user; the ability to create a master ASR user, edit the master ASR user attributes and delete the user; the ability to create a site, edit its attributes and delete the site; the ability to create an account, edit the accounts attributes and delete the site; the ability to associate a site with an account; the ability to associate a user to a site, edit the attributes for this relationship and disassociate a user from a site; and the ability to grant management access for a site to another user. The result is that the specified site becomes part of the management scope of the designated user. Further, access 216 preferably provides: the ability to grant management access for an account to another user, the result is that the specified account becomes part of the management scope of the designated user; and the ability to grant management access for a user to another user. The result is that the specified user becomes part of the management scope of the designated user.

Preferably, a user is only permitted to manage (e.g., edit attributes or delete the entity) an entity (e.g., a user, site, account) for which the user has management authority. By default a user preferably has management authority for all entities which are created by that user. In addition a user may be granted management authority to an entity.

Continuing with reference to FIG. 2, rendering services 222 provide a framework to render media assets with the ability to transform a content item (e.g., a “hit”) from the item's form or representation into another form. For example, rendering services 222 are used to render a selected set of hits from raw data into a report. As used herein, the term, “rendering,” refers, generally to the ability to transform a content item, or a collection of content items, from a first form or representation into another form or representation. For example, a list of hits may be rendered to be displayed in HTML, for viewing on a web page. Alternatively, the list may be rendered to be formatted in ADOBE PDF format, MICROSOFT MS-Word (.doc) format, or, alternatively in a format for a respective e-mail client application. Rendering preferably applies to all content types within the architecture 200 including, for example, news items, editorial items, advertisements, broadcast content items and internet-source content items.

Thus, various types of rendering are envisioned herein, including, for example, rendering a set of content items into HTML for browser window display, rendering a set of content items into a text-based email message, rendering a set of content items into an MS Word .doc file, rendering a set of content items into a PDF document, and rendering a set of content items into a media center showroom for viewing by a guest user (described above). E-commerce services 224 provide facilities to support online sales of products, such as media clips and video segments.

Moreover, reporting and analysis services 228 offer an ability to provide analytical data to customers using a variety of reporting formats and tools. As used herein, “reporting” and “analysis” are treated similarly in architecture 200, thereby enabling users to produce various reports, including charts, graphs, and spreadsheets, for example, for analysis. Further, access tracking and reporting services 230 offer the ability for users to track access to web-based resources and generate access reports. This preferably enables a media center subscriber to monitor who has accessed a particular showroom and the content that was viewed. Furthermore, gateway services 232 provide facilities for integrating systems 233 that are external to common services 206. In a preferred embodiment, gateway services 232 map an account number in a first account to an account number in one of the supported external systems. Moreover, gateway services 232 preferably retrieve selected account information from supported external systems. This information is used, for example, to pre-populate a new account, or to validate account information against an external system. For example, financial systems (e.g., that are internal to a proprietor of the present invention), as well as payment processing services and data-related services (e.g., feeds of ratings information, media contact information, or the like), that are external to a proprietor of the present invention are supported. Preferably, a tight coupling exists between gateway services 232 and a related data transaction gateways 234 component. Respective implementations of architecture 200 preferably determine the particular structures of gateways 232 and 234, as well as multi-tiered approaches therefore.

Continuing with reference with FIG. 2, search services 236 include a set of components that provide comprehensive and customized search capabilities to applications seeking media assets in IMI repositories 210. Moreover, security component 238 preferably provides fundamental security functions, such as authentication and authorization. Although security component 238 is illustrated in FIG. 2 as a common service, it is to be understood that security component 238 is pervasive throughout the common services 206 and IMI repositories 210. Additionally, notification services 240 preferably provide general facilities for sending various types of notifications and other information to users, customers as well as to internal personnel. As used herein, notifications are preferably include email/fax distribution of reports and delivery of alerts to customers.

Also shown in FIG. 2, delivery services 242 preferably provide support for the delivery of various products, services and notifications, as taught herein, through various delivery channels 243. Products and services preferably include the delivery of various reports, typically via email, as well as the delivery of products purchased on-line such as video segments and advertisements. Various delivery channels 243 are supported including electronic delivery (email, fax, download) and physical commercial delivery. Moreover, service management 244 includes a set of functions which support operations in architecture 200, including functions for supporting information technology (“IT”) service management and planning functions, such as capacity management, performance management and availability management. This preferably includes features such as operational event tracking and notification, instrumentation of various services and the capture of metrics to support IT service planning and management activities. Additionally, folder management component 246 preferably includes a centralized ability for a user to manage folders (e.g., company folders, personal folders, or the like) while working with one or more applications. Preferably, users can create folders and add items (e.g., hits, and articles) to the folders. Additionally, user, site, and account management component 248 provides facilities to create and manage customer accounts and customer sites for hosting media content and users who access these sites. For example, component 248 enables a user to define what a user can (and cannot) view on a site (e.g., issues, publishers), particular reports and analysis a user is authorized to access, and features a user is granted access to, such as a scorecard.

Continuing with reference to FIG. 2, business services 250 extend services to provide various benefits, including to develop and support a wide market of customers, an increased market share, additional products and product suite services, increased name and branding services, an increased customer base, and additional revenue from patrons and new customers. Hence, services 206 support the implementation of strategic services for customer data services 252 and partners 254.

For example, a public relations (“PR”) agency offers various PR-related services to the agency's clients. The PR agency contracts for content services from a proprietor of the present invention to allow the agency to obtain various news and editorial content from through various interfaces, described herein. The content is preferably packaged by the PR agency and re-sold to the agency's customers. Business services 250 preferably extends media content to a wide variety of service offerings, and is preferably available through well-defined, standards-based interfaces (e.g., web services). For example, business services, perhaps based upon standard web services protocols, preferably accesses data hosted by systems owned by a customer, and the data is preferably included in advanced analysis scenarios including, for example, campaign response analysis.

Thus, and as illustrated in FIG. 2, a plurality of components, services and processes are supported and/or provided that operate via enterprise architecture 200 in accordance with the teachings herein.

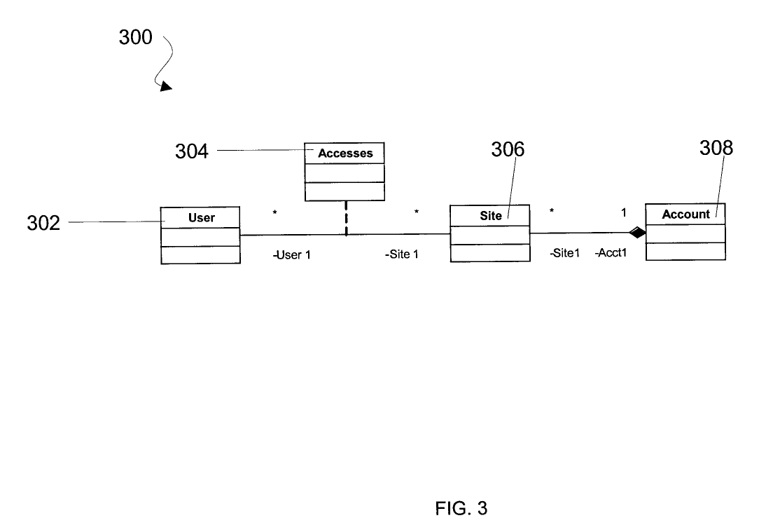

FIG. 3 is a unified modeling language (“UML”) class diagram, as known in the art, illustrating relationships 300 of users to sites, and sites to accounts. As shown in FIG. 3, a user-site relationship is shown representing a relationship in which a user 302 accesses 304 a site 306. In a preferred embodiment, the relationship is defined as a “many-to-many” relationship, in which a user 302 may access 304 many sites 306, and a site 306 can be accessed 304 by many users 302. The user-site relationship preferably holds attributes that specify respective permissions a user 302 has for a particular site 306.

Continuing with reference to FIG. 3, an account-site relationship is illustrated for a relationship in which an account 306 “covers” a site 308. In a preferred embodiment, the relationship is defined as a one-to-many relationship, in which a single account 308 can cover multiple sites 306. The practical implication is that a single account 308 will be billed for all sites 306 that that account 308 covers. In addition, the site 306 is preferably associated (i.e., it “depends”) on the account 308.

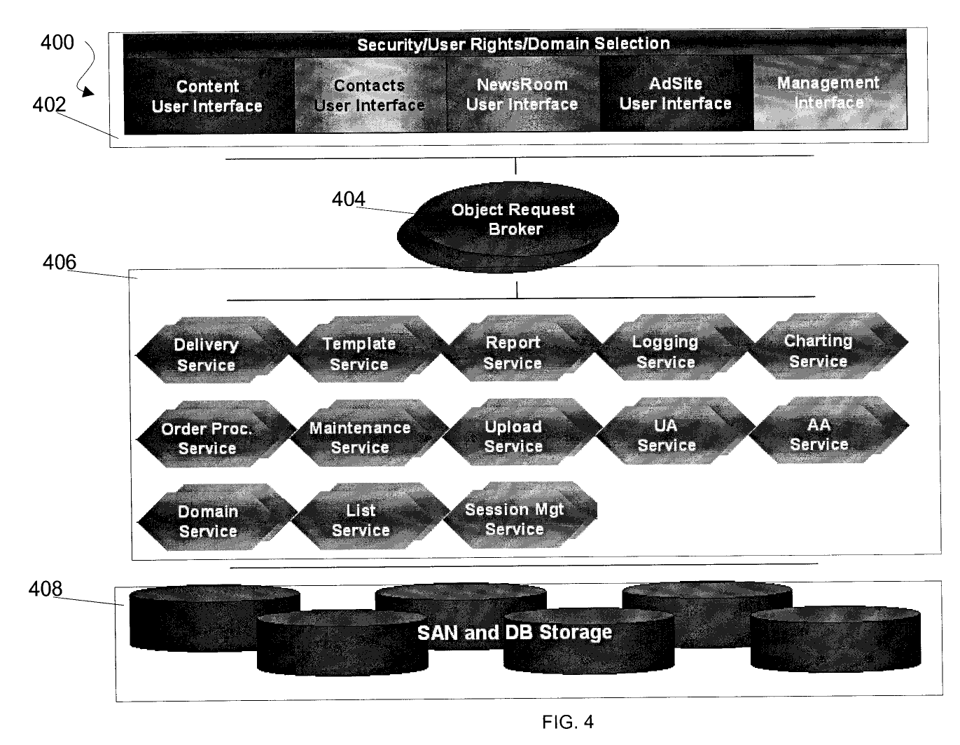

Furthermore, a redundant, distributed architecture is preferably provided, including scalable systems and services. FIG. 4 is a block diagram representing a graphical view of an architecture 400 implemented in accordance with an embodiment that resembles at least in part architecture 200 (FIG. 2). As shown in FIG. 4, four partitions are illustrated that include security/user rights/domain selection interfaces 402, an object request broker 404, a plurality of templates and services 406, and a storage area network (“SAN”) and database (“DB”) storage 408. The interfaces 402 include interfaces for content, such as INSIGHT CONTACTS, NEWSROOM, ADSITE and APEX, offered by the assignee of the present patent application. Object request broker 404 preferably manages data object requests from the respective interfaces to and from various services 406, including for content delivery, templates, reports, logging, charting, order processing, maintenance, uploading, user attributes, application attributes, domain service, list service and session management services, as described herein and/or known in the art. Data provided in connection with the services are preferably stored in storage 408.

As used herein, the term “application” refers, generally to a discreet collection of services and templates as presented in a user interface for a specific business function for a given site. By way of example INSIGHT CONTACTS, offered by the assignee of the present invention, is an application, as is ADSITE 4.0.

Templates are provided that are preferably formatted as cascading style sheets and present objects, other templates and call services in a user interface for a given application. Templates are preferably reusable across sites and applications. Templates manage the transparency for the objects they contain and the access to services presented based on permissions derived for the specific instance of a session, user, site and application. Templates also preferably support embedded server and client side scripting and address formatting issues in presentation such as table/cell width, fonts and sizing etc. Initial template types include; pages, menus, lists, charts and items.

Page templates are further provided and displayed in the main well (i.e., a portion of a page template) or via pop up display screens and support menus lists, items, data elements, functions and services calls.

Master Page templates comprise a header, main well and toe line. Each site preferably has only one master page associated with it. The header preferably contains customer branding, a quick search form and advanced search link and an application selector if the user-site for the current session has permissions for more than one application.

The object request broker is preferably a rules-based traffic manager that knows where services or data are located and routes and resolves requests for the services transparently to the application. This facility addresses load balancing, redundancy and SAN storage while freeing resources for performing maintenance without resulting in down time by shifting service or data calls to redundant servers.

Objects are essentially the raw elements presented in the user interface. Objects include menus, forms, links, data, service calls, template calls and referenced elements such as images or video clips.

Sites are logical collections of applications, users and data specific to a given account. For example, DELL COMPUTER might have a site with ADSITE, INSIGHT CONTENT and CONTACTS supporting two hundred users with two years worth of content.

Services represent the underlying processing and functionality supporting activities on sites. Ingestion, indexing and template rendering are all services. Such services may or may not have an associated user interface, as appropriate.

Sessions preferably reference a specific user session for a specific site. Sessions also manage dynamic lists or the state of a given user from page to page. A session is initiated for each user when logging in to a site.

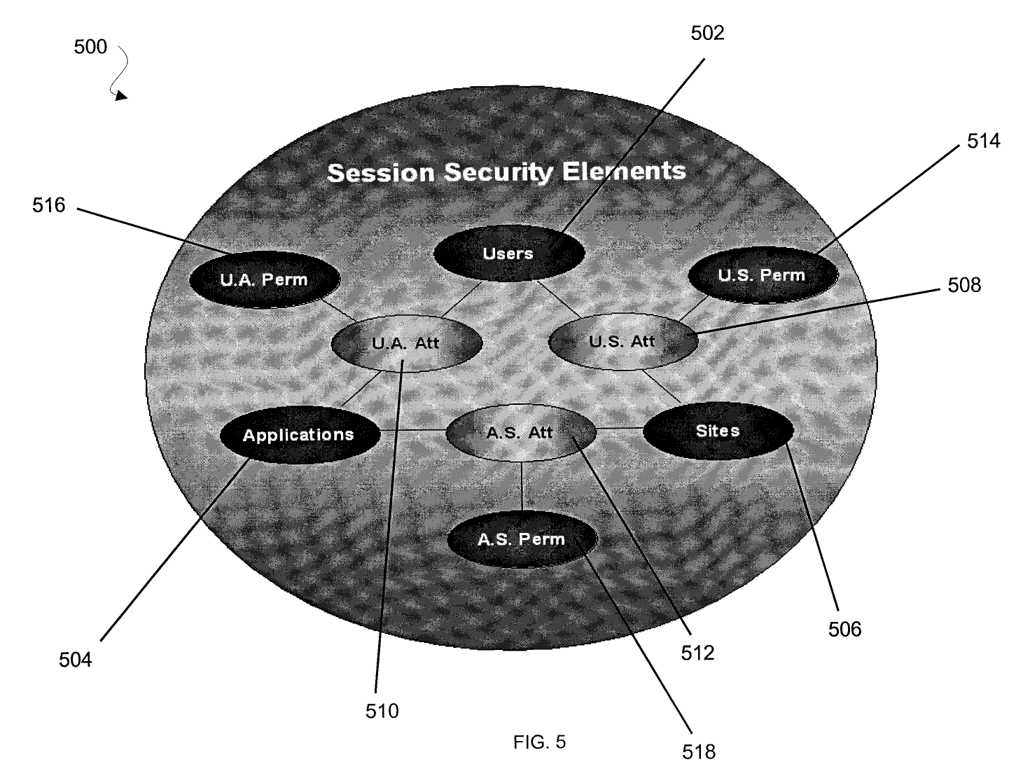

FIG. 5 is a chart illustrating session security elements 500 that are defined in accordance with a preferred embodiment. Preferably, security and user rights are central elements of this package, are provided for a plurality of data sources, such as database tables, and the security and user rights preferably support a need for both federated login pages and branded, site specific, login pages. On logging in from the federated login, users with access to more than one site are preferably prompted to select a site on which they would like to work. Those logging in through the federated page with access to only one site are preferably directed only to a site for which they are authenticated. Users logging in through the branded login pages are preferably directed to a respective site associated with the login page. Upon a successful login, the present invention initiates a “session” for the user on the particular site accessed with the permissions appropriate to that specific instance of user and site. Preferably, a secured communications protocol (e.g., “HTTPS”) is used for any communication session in which passwords, orders, or proprietary information are collected or displayed, as well as when any proprietary or personal information held on the site such as credit card numbers.

Structurally, the permissions for a given user for a given site and/or for a given application are preferably interdependent and established during the log in process as a site is selected. As the list of permissions for each of these elements increases over time, the definition of permissions is preferably driven through table entries for each of three permutations: user 502, site 504 and application 506, as desired. Provisions are preferably made to insure that client content is not publicly available or visible to users of other sites unless the end user has elected to publish the data in some manner.

In one embodiment, a data table is preferably provided that represents users 502, and rows of the users table preferably contain elements common to a user across all instances of a sites and applications. For example, data elements may include: user name, e-mail address, alert e-mail address, password, credit card information, and contact information. Further, a data table is preferably provided that represents sites 504, and rows of the sites table preferably contain data elements explicit to a respective site regardless of the user or application being utilized in a given session. For example, data elements in a sites table may include: site name, logo, content feed ids, login page, HTML page name values, volume limits, and site content repositories. Furthermore, a data table is preferably provided that represents applications 506, and rows of the applications table preferably represent various IMI applications and tiers of services. For example, data elements in the applications table may include: application name, service level, trial site, and pointers to help documents.

The user-site attributes (“U.S. Att”) table 508 preferably comprises rows of data that join users to sites and identify the associated permissions in “user-site” permissions granted to a given user for a given site along with any modulating variables or arguments. These permissions preferably control the transparency of the associated objects and services for a given user/site session. The U.S. Att table preferable includes four fields; user_id, site_id, user_site_permissions_id, and arguments.

The user-application attributes (“U.A. Att”) table 510 preferably comprises rows of data that join users to applications and identify the associated level of service subscribed to for a given user on a given site. These permissions preferably control the transparency and nature of access for a given application for a given user/site session.

The application-site attributes (“A.S. Att”) table 512 preferably comprises rows of data that join sites to applications and identify the associated level of service subscribed to for a given application in a given site. These permissions preferably control the transparency and nature of access for a give application for a given user/site session.

The user-site permissions (“U.S. Perm”) table 514 preferably includes rows of data that identify tunable permissions applicable to users and sites. For example, data elements include: Can Order QV, Can Order Tape, Can Edit Segments, Can View MPI, Can Application Name, Service Level, Trial Site, and pointers to Help Documents.

The user-application permissions (“U.A. Perm”) table 516 preferably includes rows of data that identify tunable permissions applicable to users and applications. For example, data elements include: can distribute, read only, disable use, trial account, application visible and display ad.

The application site permissions (“A.S. Perm”) table 518 preferably includes rows of data that identify tunable permissions and attributes applicable to sites and applications. For example, data elements include: can distribute, image storage length, read only, disable use, trial account, application visible and display ad.

The transparency for some elements may be controlled by more than one value from one or more of the attributes tables.

In practice, the session management service preferably logs user and site activity including page displays, last login, errors encountered, orders placed and processed as well as other features requested by embedding a “logging” function call in a page display. Logging records are preferably stored in a respective table and include three types: accumulated records (e.g., page displays, orders placed, or e-mail's sent), transactional records (e.g., error messages and credit or service requests) and transitional events (e.g., last login, last edit, last report distribution). Logging classifications are preferably stored in a respective table, including an id field, description and type id. Logged events preferably reside in a joined entity and identify insert date, update date, session id, user id, site id, application id, log event id and log event type and a description field passed by logging function calls.

Once a user provides a valid user id and password, and selects a site, the session manager preferably establishes appropriate permissions for that session and launches the master page template and display page identified in the user-site attributes table. A facility for e-mailing forgotten passwords is preferably available from a login page and any resent passwords are preferably logged. While password management services may not be required, one skilled in the art will recognize that the architecture supports such services, if desired.

Preferably 128-bit encryption is supported and separate key sets are generated at both the site and user level. Confidential fields such as credit card numbers and sales projections are preferably encrypted and stored in a database. Users uploading content to a site also preferably have the option of applying site or user specific encryption. Additionally, all “put” transactions are preferably provided via the HTTPS communication protocol.

Further, various “common services” are supported that include a set of reusable components supporting the entire IMI infrastructure. The activities supported by these services are preferably compartmentalized to the greatest extent possible to more readily support enhancements and future modifications.

In one embodiment, the present invention provides an alerts/triggers service to launch exception reports, monitor system performance and initiate client and account services notifications based on timed or event based activity against user-defined events. Examples include alerting clients at regular intervals to new news coverage posted to their sites, advising support staff of content that could not be properly ingested or advising sales staff when an account exceeds an anticipated run rate.

In another embodiment, a charting service is preferably provided to render charts that “tunnel down,” as known in the art, to lists of the supporting coverage for display and inclusion in larger reports.

A delivery service option is preferably provided to support the delivery of user-generated material. The service preferably monitors and tracks the delivery status for a given transfer to the greatest degree possible and logs the information as appropriate and tracks and reports exceptions. Protocols supported preferably includes E-mail, RSS, FAX, HTTP, MMS, FTP and “pod casts,” as known in the art.

Further, an order processing service is preferably provided to support electronic ordering of services. This service preferably supports both account-based purchases and credit card orders as determined by the permissions established for a given user on a given site. Fulfillment for some “orders” such as audience values or QV previews will be completed automatically and other item may require physical delivery. The order processing service preferably supports a traditional shopping cart purchase with pricing from the sites table. End users are preferably able to track the progress of their orders through this process as well. The initial life cycle for orders are preferably “pending”, “in process”, and “delivered” but the definitions for this lifecycle are preferably table based and tunable by product. The order processing service also preferably initiates site based notifications of new orders via the delivery service and export order information to backend billing and OEOP systems such as pilot.

A maintenance and management service is an internal service supporting a proprietor of the present invention and related staff in administering the system as a whole. This service preferably provides user and site management statistics including exception reporting. This service further manages user and site account information and template selection and the other values necessary to initiate and manage an account. This service preferably conducts and monitors account based maintenance activities such as purging content, creating archive CD's and cleaning out expired data. The service preferably supports a proprietor of the present invention and related staff in administering the system as a whole by collecting and tracking user and site management statistics including, for example, exception reporting and allowing for support staff to manage and track user and site account activity such as usage, template selection, session values and other system values as necessary to initiate, manage accounts and address various issues.

Moreover, a billing service is preferably provided that supports the creation of export files supporting the billing and invoicing for INSIGHT services and content. This service preferably is able to track and manage royalty payments for content as necessary and produce reports of incremental billable activity as necessary. The service preferably also allows customers with appropriate permissions to review the billable activity for their accounts and the status of their accounts. A proprietor of the present invention may be required to provide royalty reports to a number of data providers and accordingly, anticipate growth in the number of suppliers requiring this service over time. Thus, logging and capturing activity is performed and associated with licensed material. This service preferably is able to render electronic billing and royalty reports in a format consistent with the examples identified in appendix 1a.

In addition, user maintenance is preferably performed in the Maintenance/Management service, and end users preferably have access to a facility that allows them to establish their preferences and configure their sites, provided they have been granted appropriate permissions. For example, data elements are provided for home page selection, default sort order, password, e-mail address, purchasing preferences, and report format preferences. Users with additional authorization, such as “administrative” permissions are preferably able to edit and update these values for other users on their site.

Further, a search functionality is preferably provided. Users are preferably able to search by virtually any piece of metadata associated with content and the richer searching tools are preferably provided. All content is preferably indexed and searchable as it is added to or modified on the site. Preferably, a searching service preferably supports full Boolean and proximity queries, as well as search term suggestion, conceptual clustering, and proximity, positional, and frequency operators. The search service is preferably closely coupled with the database operations, thereby enabling DB and textual queries to be handled in a single consistently formatted service call.

Additionally, content ingestion and data normalization services are preferably provided to manage and process content from third party sources. As such, the ingestion process is preferably extremely robust and flexible. Broadly, the ingestion process preferably collects content in a number of formats via a number of push and pull communication protocols. Based on account information in the feed, the content is preferably processed for delivery to a specific site and information from the feed is preferably normalized against master tables in the application for information like publisher, market, affiliate, city, state and country. This content is preferably subjected to any account based transformations such as image modifications, market reassignment or automated annotations as identified in the site instructions and stored in the appropriate content repository for display or subsequent processing. Each stage in the article ingestion process are preferably given its own identifier so that the content progress through ingestion can be traced and problems and exceptions are preferably reported and logged by the alerting and logging services.

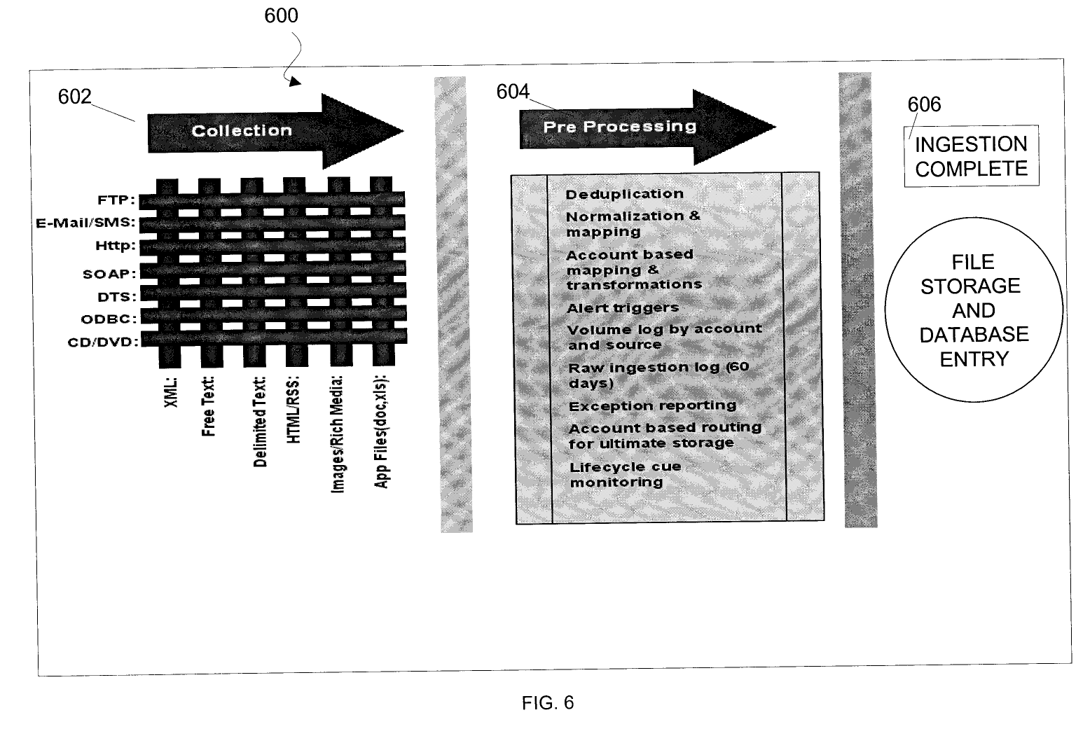

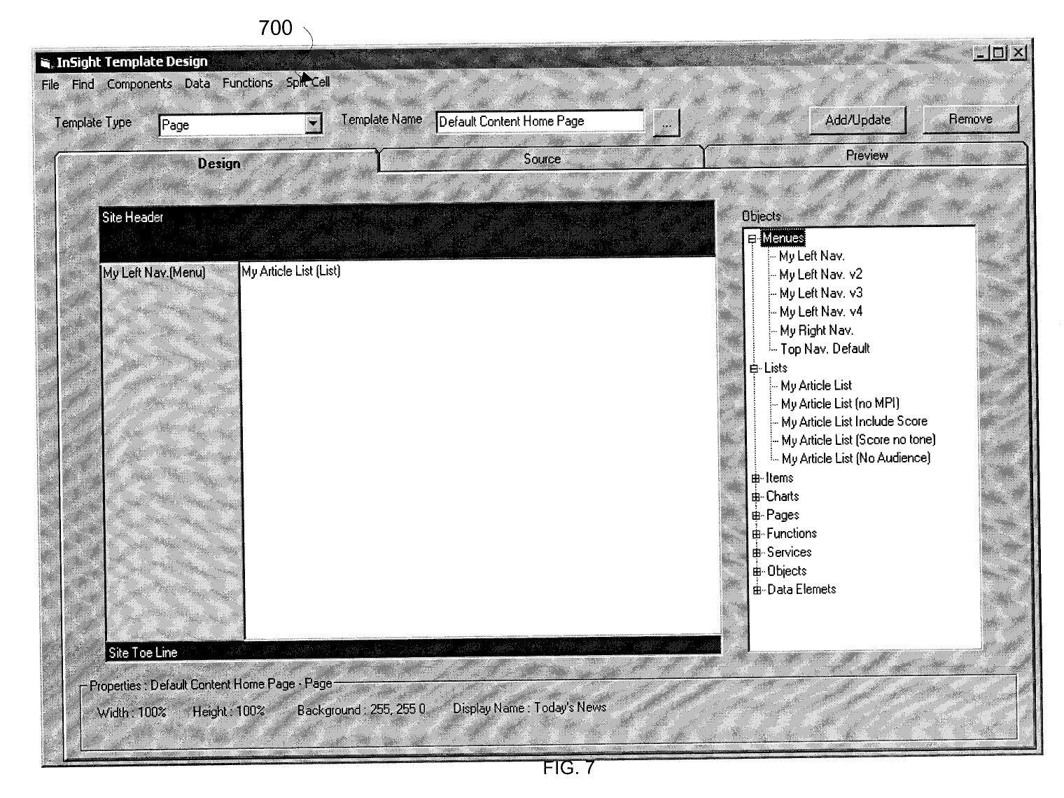

FIG. 6 illustrates steps 600 associated with collection 602, pre-processing 604 and completion of ingestion 606, in accordance with a preferred embodiment of the present invention. Collection 602 of data may occur via various known processes or sources, FTP, e-mail (SMS), HTTP, SOAP, DTS, ODBC, or via reading a drive, including CD/DVD, or other method of data transfer as known in the art. The data may be formatted in various ways, including XML, free text, delimited text, HTML/RSS, images (or rich media), or in formatted application files, such as MS-EXCEL spreadsheet files, or other format as known in the art. During the preprocessing 604 stage, various processes are performed on the collected data. For example, duplicate data are removed, data are normalized and mapped, account-based mapping and transformation occurs and alert triggers are set, as known in the art. Further, a volume log by account and source is generated, as is an ingestion log for a set period of time, such as 60 days. Moreover, exception reporting is preferably provided and account-based routing for eventual storage occurs. Moreover, data lifecycle cue monitoring is provided. Once complete 606, file storage and database entry performed.

Preferably, users upload their own content and/or data and a manual upload service provides a user interface to the ingestion service. In an embodiment, a publishing service supports editors in the preparation of content for presentation on sites. Moreover, a rendering service may be provided, for example in one or more embodiments for collecting data, templates and objects necessary to populate page as requested in a user interface and, thereafter, to present the information in an appropriate manner through the user interface. The rendering tool preferably updates the session management service to reflect changes in the state of the user session as appropriate.

Preferably, a session management service is responsible managing the state of a user while they are actively using the application. This includes managing state, user selected lists of articles or shopping carts or the status of reports being rendered through multi page wizards. A utility within the session management service further preferably allows support staff to monitor the state of a given user and any errors that may be occurring in their interaction with the site. Moreover, the session management service preferably identifies multiple user utilizing a single account and conditionally lockout users based on permissions in the user-sites table.

Moreover, a template management service is available for the proprietor of the present invention and corresponding staff to construct reusable template or style sheets for the presentation of information and services on customer sites. These templates preferably allow users to embed other templates in a cascading manner and support the embedding of functions, conditional logic and data elements within the template definitions.

FIG. 7 illustrates an example template management service display screen 700 in accordance with a preferred embodiment. The following describes templates elements thereof that are preferably available via the template management service.

Master Page Templates: These templates include a header, main well and toe line. Each site preferably has only one master page associated with it. The header preferably contains customer branding, a quick search form and advanced search link and an application selector if the user-site for the current session has permissions for more than one application. Selections made by an application selector launch the selected application pages in the main well. The main well initially displays a user defined start page for the site and updates to reflect the user's activity and interaction with the site. The toe line is a status bar/and navigational aid of sorts and preferably cannot be edited.

Page Templates: Page templates are displayed in the main well or via pop ups and can support menus lists, items, data elements, functions and services calls. They are essentially the guts of the active application.

Menu Templates: Menus allow the user to launch pages against target frames and initiate service calls and functions.

List Templates: Lists contain and display data results populated based on the query property. They may be configured to display result sets as full lists or paged results. The items presented are ordered by the fields defined in the “order by” property of the template. Lists can be present items in a grouped or banded report formats based on a “group by” property.

Item Templates: Items are intended to format records of result sets for display and should be able to incorporate conditional logic, functions and service calls.

Chart Templates: Chart templates preferably address the design and lay out of graphs and charts against lists of data results.

Preferably, objects that are provided in accordance with the template management service include lists, items, menus, actions, icons and images.

As noted above and illustrated FIG. 4, data storage 408 is an integral element of the present invention. Storage of physical files is preferably organized on a SAN such that the visibility of content and access to files is organized by site. Public access to files is permitted via service calls that carry an appropriately formatted and encrypted token, which will identify the user who published the information. Absolute file locations are preferably managed by the object request broker such that calls to the object request broker identifying the site, item_image_id, and session_id or public token will resolve to produce a full URL for the resource.

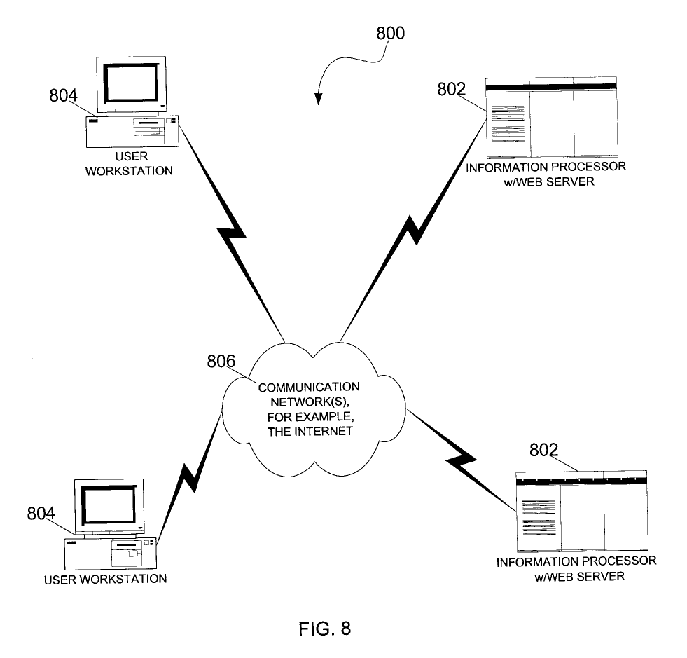

FIG. 8 illustrates an example hardware arrangement, in accordance with an embodiment of the present invention, and referred herein, generally, as system 800. In the example shown in FIG. 8, information processor(s) 802 are operable to function as Internet web servers, as known to those skilled in the art.

Information processor 802 preferably includes all databases necessary to support the systems and methods described herein. However, it is contemplated that information processor 802 can access any required database via communication network 806 or any other communication network to which information processor 802 may be coupled. Communication network 806 is preferably a global public communication network such as the Internet, but can also be a wide area network (WAN), local area network (LAN), or other network that enables two or more computers to communicate with each other.

In a preferred embodiment, information processor 802 and user workstation 804 are any devices that are capable of sending and receiving data across communication network 806, e.g., mainframe computers, mini computers, personal computers, laptop computers, a personal digital assistants (PDA) and Internet access devices such as Web TV. In addition, information processors 802 and user workstations 804 are preferably equipped with web browser software, such as MICROSOFT INTERNET EXPLORER, MOZILLA FIREFOX, or the like. Information processors 802 and user workstations 804 are coupled to communication network 806 using any known data communication networking technology.

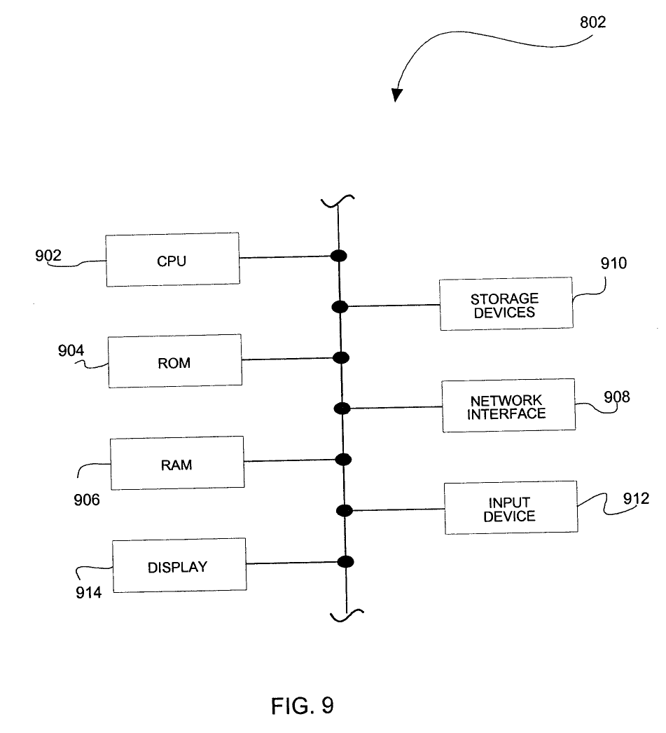

FIG. 9 illustrates the functional elements of an example information processor 802, and includes one or more central processing units (CPU) 902 used to execute software code and control the operation of information processor 802. Other elements include read-only memory (ROM) 904, random access memory (RAM) 906, one or more network interfaces 908 to transmit and receive data to and from other computing devices across a communication network, storage devices 910 such as a hard disk drive, floppy disk drive, tape drive, CD ROM or DVD for storing program code databases and application data, one or more input devices 912 such as a keyboard, mouse, track ball, microphone and the like, and a display 914.

The various components of information processor 802 need not be physically contained within the same chassis or even located in a single location. For example, storage device 910 may be located at a site which is remote from the remaining elements of information processor 802, and may even be connected to CPU 902 across communication network 806 via network interface 908. Information processor 802 preferably includes a memory equipped with sufficient storage to provide the necessary databases, forums, and other community services as well as acting as a web server for communicating hypertext markup language (HTML), Java applets, Active-X control programs or the like to user workstations 804. Information processors 802 are arranged with components, for example, those shown in FIG. 9, suitable for the expected operating environment of information processor 802. The CPU(s) 902, network interface(s) 908 and memory and storage devices are selected to ensure that capacities are arranged to accommodate expected demand.

As used herein, the terms “link” and “hyperlink” refer to a selectable connection from one or more words, pictures or other information objects to others in which the selectable connection is presented within a web browser software display. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of information processor 802 shown in FIG. 9 are of the same categories of functional elements present in user workstations 804. However, not all elements need be present in the user workstation 804. For example, storage devices, in the case of PDA's, and the capacities of the various elements are arranged to accommodate the expected user demand. For example, CPU 902 in user workstation 804 may be a smaller capacity CPU than the CPU present in the information processor 802. Similarly, it is likely that the information processor 802 will include storage devices of a much higher capacity than storage devices present in user workstation 804. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, and a plurality web site development applications.

Although the present invention is described by way of example herein and in terms of a web-based system using web browsers and a web site server (e.g., information processor 802), system 800 is not limited to such a configuration. It is contemplated that system 800 is arranged such that user workstation 804 communicates with and displays data received from information processor 802 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 802 and user workstation 804, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, MAC OS, UNIX, LINUX, PALM OS, POCKET PC and any other suitable operating system.

As used herein, references to displaying data on information processor 802 and user workstation 804 regard the process of communicating data across communication network 806 and processing the data such that the data is viewed on a display 914, for example by using a web browser and the like. As is common with web browsing software, the display 914 on user workstation 804 presents sites within the system 800 and architecture 200 (FIG. 2) such that a user can proceed from site to site within the system by selecting a desired link.

Therefore, each user's experience with system 800 is based on the order with which he/she progresses through the display screens. Graphic controls are preferably available in the display screens and modules to initiate data processes, and to provide convenient navigation between the display screens and modules of system 800. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 800.

Various applications are envisioned herein. For example, one application offers fast access to competitive advertising intelligence across all media and provides comprehensive occurrence and spend data through a fully customizable online content/data management dashboard. The software allows users to organize, manage, report on and distribute competitive ad clips, data and reports easily and efficiently.

Another application is a premium module providing a comprehensive directory of media outlets and contacts. This module is available online 24 hours a day, 7 days a week and includes information from all media and markets—including local and national newspapers, cable, network and local television stations, local radio stations, radio networks, and magazines.

Yet another application allows public relations departments to create, distribute and track coverage from press releases within a single environment and establishes a public site for reporters and other communications professionals to access and download press releases, images, graphics and other materials quickly and easily from one location.

Still another application provides news monitoring and competitive advertising intelligence integrated across all key media in an executive dashboard tailored to marketing and communications executives.

Although the present invention is described and shown in relation to particular embodiments thereof, many other variations and modifications and other uses will become apparent to those skilled in the art. It is preferred, therefore, that the present invention be limited not by the specific disclosure herein.

What is claimed is:

1. A method for managing media received from a plurality of media sources, the method comprising:
receiving media content from a media source over a communication network, wherein the media content is formatted in a first format and comprises news material and advertising material, and further wherein the news material and the advertising material relate to the same respective subject;
processing the received media content to provide processed content, wherein the processing includes filtering the content, annotating and standardizing the content;
rendering the processed content, wherein the rendering includes transforming the processed content from the first format into a second format;
storing the processed content formatted in the second format in an electronic storage repository;
retrieving the processed content from the electronic storage repository in response to a search for the processed content;
transforming the processed content from the second format to a third format; and
delivering the processed content in the third format to a user.

2. The method of claim 1, wherein the filtering includes identifying content that is desired by a user according to rules defined by the user.

3. The method of claim 1, wherein the content is provided in at least one of a plurality of formats, and the second format is selected from a plurality of formats during the rendering.

4. The method of claim 3, wherein the media content is received in printed format, video format or electronic format.

5. The method of claim 1, further comprising providing an analysis of the processed content to the user, wherein the analysis includes the processed content and graphical representations describing of the content.

6. The method of claim 1, further comprising calculating a media prominence index value in connection with the media content and using the media prominence index value to determine a measure of impact the media content has on a viewer.

7. The method of claim 6, further comprising calculating advertising spending in connection with the media content and using the media prominence index value and the advertising spending value to determine a measure of impact the media content has on a viewer.

8. The method of claim 1, wherein the processing further comprises categorizing the media content by subject matter.

9. The method of claim 1, wherein the delivering further comprises receiving user-defined custom report templates, providing reports that comply with the custom report templates, and delivering the reports to the user.

10. The method of claim 1, wherein the subject relates to a brand, product, company, person, issue, message or personal preference.

11. The method of claim 1, further comprising providing security services that preclude access to the content to authorized users.

12. The method of claim 1, further comprising providing folder management services that enable a user to organize data folders for storing the processed media content in the third format.

13. The method of claim 1, further comprising providing a showroom repository for users to create virtual showrooms for guests.

14. The method of claim 1, wherein the media content further comprises unpaid content and paid content.

15. The method of claim 14, wherein the displaying provides an integrated representation of the unpaid content and the paid content.

16. The method of claim 1, wherein the annotating includes associating metadata with the media content.

17. The method of claim 16, wherein the metadata is generated as a function of analyzing the media content.

18. The method of claim 17, wherein the analyzing includes viewing closed-caption text provided with media content formatted as video.

19. The method of claim 1, further comprising providing e-commerce services for users to purchase the processed content.

20. The method of claim 1, wherein the advertising material is paid for by a first party and the news material is not paid for by the first party.
